(19) United States
(12) Patent Application Publication
(10) Pub. No.: US 2019/0012644 A1
(43) Pub. Date: Jan. 10, 2019

(54) MANAGEMENT SYSTEM

(71) Applicant: RINNAI CORPORATION, Aichi (JP)

(72) Inventors: Koji Okumura, Aichi (JP); Masahiko Ono, Aichi (JP); Toshihiro Shibagaki, Aichi (JP); Katsutoshi Honda, Aichi (JP); Koji Asai, Aichi (JP); Shuichi Katayanagi, Aichi (JP); Kazuya Hirota, Aichi (JP)

(21) Appl. No.: 16/025,458

(22) Filed: Jul. 2, 2018

(30) Foreign Application Priority Data
Jul. 4, 2017 (JP) 2017-131449

(51) Int. Cl. G06Q 10/00; G06Q 10/08

(52) U.S. Cl. CPC G06Q 10/20; G06Q 10/0875; G06Q 10/083

(57) ABSTRACT

The server may be configured to: estimate a total number of the new replaceable components to be purchased by the user of the device at the predetermined timing that is before the replacement timing; based on the estimated total number of the new replaceable components to be purchased and based on a stock quantity of the replaceable components at the predetermined timing, calculate a quantity of stock shortage of the replaceable components at the predetermined timing; and generate replenishment information for replenishing stock of the replaceable components according to the calculated quantity of stock shortage of the replaceable components.

### TECHNICAL FIELD

The technique disclosed herein relates to a management system.

### BACKGROUND

A management system described in Japanese Patent Application Publication No. 2002-092439 includes a server (management computer) and a plurality of devices (printers) configured to communicate with the server. Each of the devices (printers) uses various replaceable components such as ink tank. Each replaceable component (ink tank, etc.) reaches a replacement state where the replaceable component is required to be replaced due to exhaustion by use. The server calculates a replacement timing of each replaceable component used in each of the devices. Further, the server generates replenishment information for replenishing stock of the replaceable components based on a quantity of the stock of the replaceable components.

### SUMMARY

In the management system of Japanese Patent Application Publication No. 2002-092439, the respective replaceable components (ink tank, etc.) are used in the respective devices (printers), and a state of use of each replaceable component used in each device differs depending on states of operation of the devices. Due to this, timings at which the replaceable components reach their replacement state differ depending on the devices. Some replaceable components reach their replacement state early, while other replaceable components reach their replacement state later. Depending on a situation as above, replacement timings to replace the replaceable components which a user of each device uses with new replaceable components come differently. Further, a timing for the user of each device to purchase the new replaceable components for replacement also comes differently. Due to this, a total of purchase quantity of the new replaceable components to be purchased by the users of the plural devices becomes different depending on timings. Since this affects a stock quantity of the replaceable components at those respective timings, the quantity of the stock of the replaceable components varies depending on the timings. If a deficiency occurs in the quantity of the stock of the replaceable components, an inconvenience may occur for the users of the respective devices when they purchase the new replaceable components for replacement. The disclosure herein provides a technique which enables to suitably manage a stock quantity of replaceable components.

A management system disclosed herein may comprise a server and a plurality of devices configured to communicate with the server. A replaceable component may be used in each of the devices, each of the replaceable components used in the devices is to be replaced with a new replaceable component when the replaceable component reaches a replacement state, the replacement state being a state in which the replaceable component is required to be replaced due to exhaustion by use, each of the devices may send information to the server, the information being capable of identifying that the replaceable component was used in the device. The server may be configured to: when receiving the information from one of the devices, calculate a replacement timing for the replaceable component used in the device based on a predetermined exhaustion rate of the replaceable component used in the device, the replacement timing being a timing at which the replaceable component used in the device reaches the replacement state, and at a predetermined timing before the calculated replacement timing for each of the replaceable components, the server may further be configured to: send replacement information to the device among the devices and/or a terminal corresponding to the device, the replacement information being for informing a user of the device that the replacement timing of the replaceable component used in the device is nearing and/or generate shipping information for shipping the new replaceable component to the user of the device; based on the sending of the replacement information and/or based on the generating of the shipping information, estimate a total number of the new replaceable components to be purchased by the user of the device at the predetermined timing that is before the replacement timing; based on the estimated total number of the new replaceable components to be purchased and based on a stock quantity of the replaceable components at the predetermined timing, calculate a quantity of stock shortage of the replaceable components at the predetermined timing; and generate replenishment information for replenishing stock of the replaceable components according to the calculated quantity of stock shortage of the replaceable components.

### BRIEF DESCRIPTION OF DRAWINGS

FIG. 1 is a diagram showing a configuration of a management system 1 according to a first embodiment;

FIG. 2 is a perspective view of a device 20 according to the first embodiment;

FIG. 3 is an example of a first table 501 according to the first embodiment;

FIG. 4 is an example of a second table 502 according to the first embodiment;

FIG. 5 is an example of a third table 503 according to the first embodiment;

FIG. 6 is another example of the third table 503 according to the first embodiment;

FIG. 7 is a flowchart of a registration process according to the first embodiment;

FIG. 8 is a flowchart of an initial setting process according to the first embodiment;

FIG. 9 is a flowchart of an operating process according to the first embodiment;

FIG. 10 is a flowchart of a calculation process according to the first embodiment;

FIG. 11 is a diagram of an example of calculation at a replacement timing according to the first embodiment;

FIG. 12 is a flowchart of a shortage quantity calculation process according to the first embodiment;

FIG. 13 is a flowchart of a server-side notification process according to the first embodiment;

FIG. 14 is a flowchart of a device-side notification process according to the first embodiment;

FIG. 15 is a flowchart of a shipping process according to a second embodiment;

FIG. 16 is an example of the first table 501 according to a third embodiment;

FIG. 17 is an example of the second table 502 according to the third embodiment;

FIG. 18 is an example of the second table 502 according to a fourth embodiment;

FIG. 19 is an example of a fourth table 504 according to a fifth embodiment;

FIG. 20 is a flowchart of a date information sending process according to the fifth embodiment;

FIG. 21 is a flowchart of a date information storing process according to the fifth embodiment; and

FIG. 22 is a flowchart of a shipping process according to the fifth embodiment.

### DETAILED DESCRIPTION

A management system disclosed herein may comprise a server and a plurality of devices configured to communicate with the server. A replaceable component may be used in each of the devices, each of the replaceable components used in the devices is to be replaced with a new replaceable component when the replaceable component reaches a replacement state, the replacement state being a state in which the replaceable component is required to be replaced due to exhaustion by use, each of the devices may send information to the server, the information being capable of identifying that the replaceable component was used in the device. The server may be configured to: when receiving the information from one of the devices, calculate a replacement timing for the replaceable component used in the device based on a predetermined exhaustion rate of the replaceable component used in the device, the replacement timing being a timing at which the replaceable component used in the device reaches the replacement state, and at a predetermined timing before the calculated replacement timing for each of the replaceable components, the server may further be configured to: send replacement information to the device among the devices and/or a terminal corresponding to the device, the replacement information being for informing a user of the device that the replacement timing of the replaceable component used in the device is nearing and/or generate shipping information for shipping the new replaceable component to the user of the device; based on the sending of the replacement information and/or based on the generating of the shipping information, estimate a total number of the new replaceable components to be purchased by the user of the device at the predetermined timing that is before the replacement timing; based on the estimated total number of the new replaceable components to be purchased and based on a stock quantity of the replaceable components at the predetermined timing, calculate a quantity of stock shortage of the replaceable components at the predetermined timing; and generate replenishment information for replenishing stock of the replaceable components according to the calculated quantity of stock shortage of the replaceable components.

According to this configuration, since the server calculates the replacement timing for each of the replaceable components based on the exhaustion rate of this replaceable component, the replacement timing thereof can be calculated with high accuracy. Further, since the server sends the replacement information to the relevant device and/or the relevant terminal for each of the replaceable components at the predetermined timings before their replacement timings and/or the server generates the shipping information for each of the new replaceable components at the aforementioned predetermined timings, a timing at which the user of each of the devices purchases the new replaceable component can be scheduled at the predetermined timing before the replacement timing. Further, the server estimates the total number of the new replaceable components to be purchased by the users of the devices at the respective predetermined timings based on the sending of the replacement information and/or based on the generating of the shipping information. That is, in the management system as above, the server estimates the total number of the new replaceable components to be purchased based on a premise that the users of the respective devices purchase the new replaceable components at their predetermined timings. Further, in the management system as above, since the server calculates the quantity of stock shortage of the replaceable components at the predetermined timings based on the estimated total number of the new replaceable components to be purchased and based on the stock quantity of the replaceable components at those predetermined timings, the purchases of the new replaceable components by the users can be included in a schedule of stock management, and the stock shortage quantity of the replaceable components can be calculated accurately. Further, since the server generates the replenishment information for replenishing the stock of the replaceable components according to the calculated stock shortage quantity, the stock quantity of the replaceable components can be managed suitably.

Further, in the above management system, each of the devices may send date information to the server in a case of being operated by the user, the date information being capable of identifying a date on which the device was operated by the user. Further, in the case of generating the shipping information for one of the devices, the server may be configured to: estimate a date on which the user of the device is at home based on the date information received from the device; and generate the shipping information so that the new replaceable component is delivered to the user of the device on the date corresponding to the estimated date on which the user is at home.

According to this configuration, since the date information is sent to the server when each device is operated by its user, the date information regarding the date when the user is surely at home can be sent to the server. Further, since the server estimates the date on which each user is at home based on the date information, the date on which each user is at home can be estimated accurately. Further, since the server generates the shipping information so that the new replaceable component is delivered to the relevant user on date corresponding to the date estimated by the server, a possibility that the new replacement component is delivered to the relevant user on the date when this user is at home can be increased.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved management systems, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

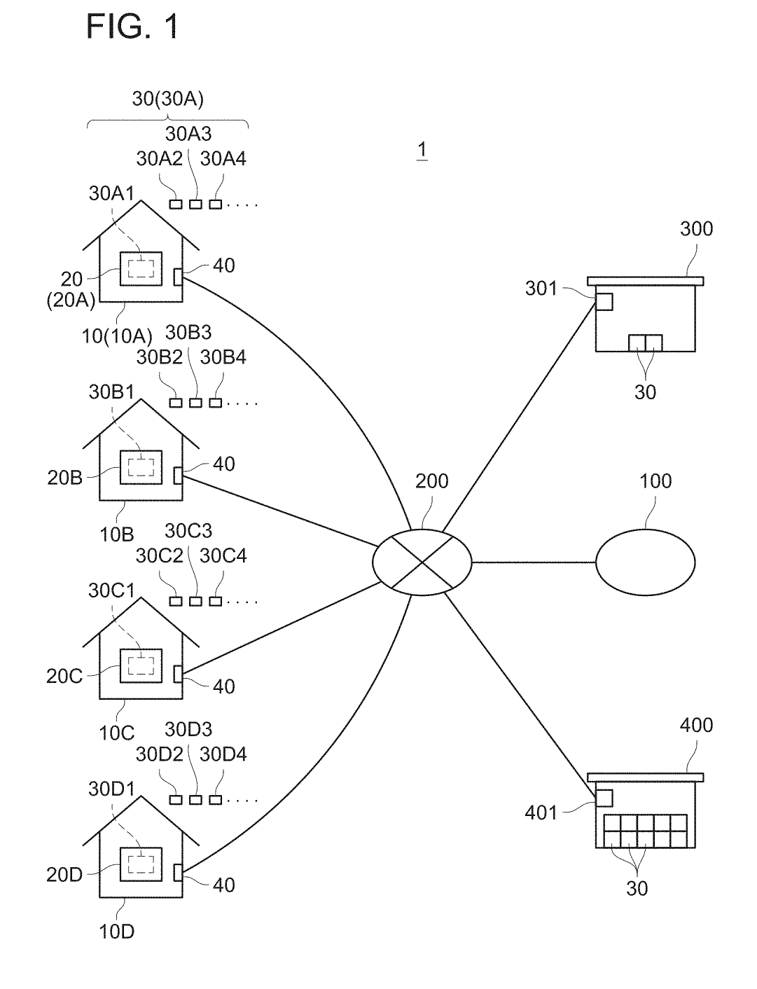

A management system 1 according to an embodiment will be described with reference to the drawings. As shown in FIG. 1, the management system 1 according to the embodiment includes a server 100 and a plurality of devices 20 (20A, 20B, 20C, 20D). Further, the management system 1 includes a first host computer 301 and a second host computer 401. The server 100, the plurality of devices 20, the first host computer 301, and the second host computer 401 are connected communicably via the Internet 200. Each of the devices 20 is connected to the Internet 200 via its router 40. Each of the devices 20 may be connected to its router 40 via a remote controller of a water heater, for example. In the description below, the plurality of devices 20A, 20B, 20C, 20D may collectively be termed devices 20. A number of the devices 20 is not particularly limited.

The server 100 of the management system 1 includes a processor, a memory, and a communication unit (all of which are not shown). The server 100 is configured to execute various types of information processing. The information processing executed by the server 100 will be described later.

The devices 20 of the management system 1 are installed in homes 10. The homes 10A, 10B, 10C, and 10D are provided with the devices 20A, 20B, 20C, and 20D, respectively. The devices 20A, 20B, 20C, and 20D are used in the homes 10A, 10B, 10C, and 10D, respectively. Although the devices 20 used in the homes 10 are not particularly limited, the devices 20 in the present embodiment are domestic dishwashers. The domestic dishwashers (devices 20) are devices that wash dishes using dishwasher detergents.

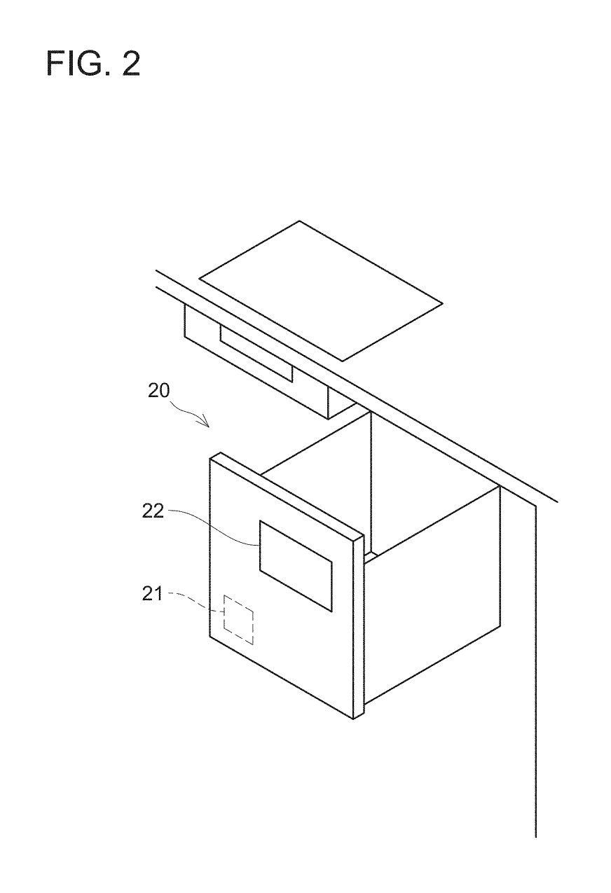

As shown in FIG. 2, each device 20 includes a controller 21 and a display 22. In addition, each device 20 further includes a memory and a communication unit (both of which are not shown). The controller 21 of the device 20 is configured to execute various types of information processing. Information processing executed by the controller 21 of the device 20 will be described later. Further, the display 22 of the device 20 is configured to display various types of information. The display 22 is, for example, a liquid crystal display.

In the devices 20 (dishwashers) in the management system 1, replaceable components 30 are used. Although the replaceable components 30 used in the devices 20 are not particularly limited, the replaceable components 30 in the present embodiment are dishwasher detergents. The dishwasher detergents (replaceable components 30) are used for washing dishes in the dishwashers (devices 20). Replaceable components (detergents) 30A, 30B, 30C, and 30D are used in the devices (dishwashers) 20A, 20B, 20C, and 20D, respectively. The replaceable components (detergents) 30A, 30B, 30C, 30D are the same product, and can be used in any of the devices 20A, 20B, 20C, 20D. In the description below, the plurality of replaceable components 30A, 30B, 30C, 30D may collectively be termed replaceable components 30. A number of the replaceable components 30 is not particularly limited. Further, a device in which the replaceable components 30 are not used can be considered as being excluded from the management system 1.

The replaceable components 30 used in the devices 20 are products that can be replaced. For example, a user of the device 20 replaces an old replaceable component 30 that was used in the device 20 with a new replaceable component 30. The old replaceable component 30 that was used is sequentially replaced with a new replaceable component 30. For example, in the device 20A, replaceable components 30A1, 30A2, 30A3, 30A4, and so forth are sequentially used and are replaced one after another. The users of the devices 20 purchase new replaceable components 30 when replacing the replaceable components 30. Each of the replaceable components 30 is given a product number.

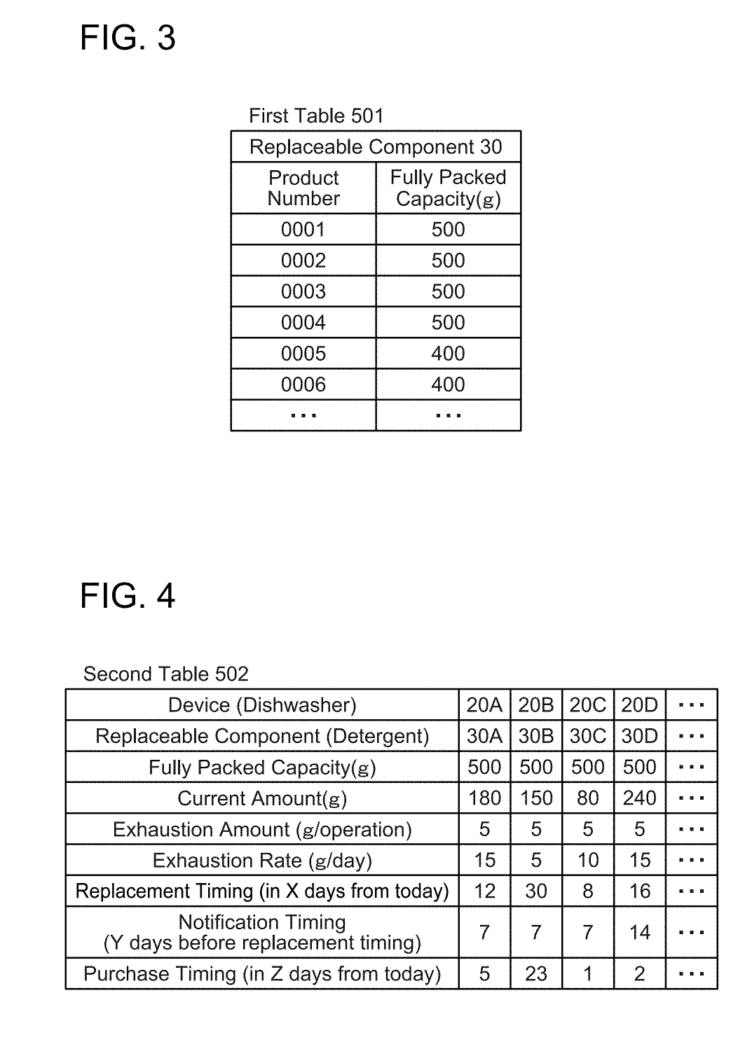

Further, the replaceable components (detergents) 30 used in the devices 20 (dishwashers) are fully packed in a brand-new state. A fully packed capacity of the replaceable components 30 (detergents) is, for example, 500 g. Each replaceable component 30 is a product in a state where the detergent is accommodated in a container, for example. When each replaceable component 30 is in the brand-new state, the fully packed capacity (500 g) of the detergent is accommodated in the container. As shown in FIG. 3, the fully packed capacity is set for each replaceable component 30 of its corresponding product number.

Further, the replaceable components 30 (detergents) are products which are exhausted by being used in the devices 20 (dishwashers). The replaceable components 30 (detergents) are used and exhausted each time the devices 20 (dishwashers) are used. In the present embodiment, the replaceable component 30 (detergent) being exhausted means that an amount of the detergent decreases. For example, as shown in FIG. 4, each time the device 20 (dishwasher) is used, its replaceable component 30 (detergent) is thereby used, as a result of which 5 g of the detergent is used and exhausted. Further, assuming that the device 20 (dishwasher) and the replaceable component 30 (detergent) are used three times per day, 15 g of the detergent is used and exhausted within a day. In the device 20A, 15 g of the detergent is used and exhausted within a day. An exhaustion rate of the replaceable component 30A (detergent) in the device 20A (dishwasher) is 15 g/day.

Further, each replaceable component 30 (detergent) reaches a predetermined replacement state when it is used and exhausted to some degree. The predetermined replacement state is a state in which a replacement of the replaceable component 30 (detergent) is required. For example, the replacement state is a state in which the replaceable component 30 (detergent), which was once fully packed in the brand-new state, is thereafter used and its remaining capacity has become 0 (zero). The replaceable component 30 (detergent) that was used and exhausted is replaced with a new replaceable component 30 when reaching the predetermined replacement state. For example, in the device 20A, when the replaceable component 30A1 which has been used reaches the predetermined replacement state, it is replaced with the new replaceable component 30A2. Similarly, when this replaceable component 30A2 reaches the predetermined replacement state, it is further replaced with another new replaceable component 30A3. The replaceable components 30 used in the devices 20 are replaced with new replaceable components 30 each time they reach the predetermined replacement state. The replaceable components 30 (detergents) are so-called consumables.

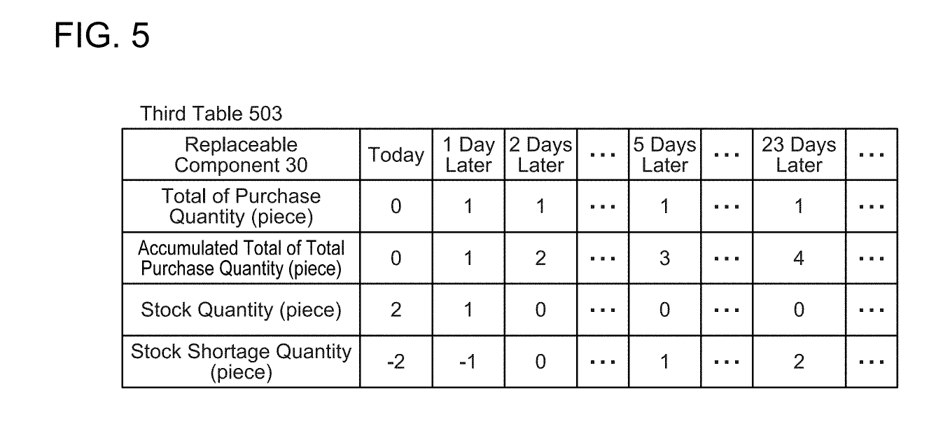

The first host computer 301 of the management system 1 shown in FIG. 1 is installed in a warehouse 300 of an administrator of the management system 1. The first host computer 301 includes a processor, a memory, and a communication unit (all of which are not shown). The first host computer 301 is configured to execute various types of information processing. The warehouse 300 of the administrator stores new replaceable components 30. That is, a stock of the replaceable components 30 exists in the warehouse 300 of the administrator. The stock of the replaceable components 30 stored in the warehouse 300 is new replaceable components 30 that are not yet used in the devices 20. The first host computer 301 sends information on a stock quantity of the replaceable components 30 stored in the warehouse 300 to the server 100. The server 100 stores the stock quantity information of the replaceable components 30 in a third table 503 shown in FIG. 5.

Further, the second host computer 401 of the management system 1 is installed in a warehouse 400 of a supplier. The supplier is a product supply source from whom the administrator of the management system 1 purchases the products (replaceable components 30). The second host computer 401 includes a processor, a memory, and a communication unit (all of which are not shown). The second host computer 401 is configured to execute various types of information processing. The supplier warehouse 400 stores a plurality of replaceable components 30 to be shipped. The second host computer 401 receives, from the server 100, replenishment information for replenishing the stock of the replaceable components 30 in the warehouse 300 of the administrator.

Next, information stored in the server 100 will be described. The server 100 stores a first table 501, a second table 502, and the third table 503.

Firstly, the first table 501 will be described. As shown in FIG. 3, the first table 501 stores the product numbers and fully packed capacities of the replaceable components 30. Each product number is information by which one type of replaceable component 30 can be identified from various types of replaceable components 30. Each fully packed capacity is an amount of detergent when the replaceable component 30 (detergent) is in the brand-new state. In the first table 501, the product numbers and the fully packed capacities of the replaceable components 30 are associated with each other.

Next, the second table 502 will be described. As shown in FIG. 4, the second table 502 stores information related to the replaceable components 30 used in the devices 20. The second table 502 stores the fully packed capacity, a current amount, an exhaustion amount, and the exhaustion rate of each of the replaceable components 30. Further, the second table 502 stores a replacement timing, a notification timing, and a purchase timing for each of the replaceable components 30. The second table 502 is updated each time the replaceable components 30 are used in the devices 20.

As aforementioned, the fully packed capacity of each replaceable component 30 stored in the second table 502 is the initial amount of the detergent at the replacement from the old replaceable component 30 to the new replaceable component 30. The fully packed capacity is, for example, 500 g.

Further, the current amount of each replaceable component 30 is an amount of the detergent currently remaining in the predetermined container. In the initial state where the old replaceable component 30 is replaced with the new replaceable component 30, the fully packed capacity is the current amount. The current amount of each replaceable component 30 decreases each time the detergent is used in the corresponding device 20.

The exhaustion amount (g/operation of the device) of each replaceable component 30 is an amount of the detergent that is used and exhausted per operation. The exhaustion amount of each replaceable component 30 is preset according to types of the device 20 and replaceable component 30. For example, the exhaustion amount of each of the replaceable components 30 is 5 g/operation.

The exhaustion rate (g/day) of each replaceable component 30 is an amount of the detergent that is used and exhausted per day. The exhaustion rate of each replaceable component 30 is calculated based on a past record of use of the replaceable component 30 in the corresponding device 20. For example, the exhaustion rate of the replaceable component 30A used in the device 20A is 15 g/day. This exhaustion rate is calculated from a record of the last 30 days that the replaceable component 30A was used in the device 20A three times per day and 5 g of the detergent was used and exhausted per each operation.

Further, the replacement timing of each replaceable component 30 is a timing at which the replaceable component 30 reaches the replacement state by being used and exhausted in its corresponding device 20. The replacement timing is a timing at which the old replaceable component 30 is expected to be replaced with the new replaceable component 30. The replacement timing is calculated based on the current amount and the exhaustion rate of the replaceable component 30. For example, if the current amount of the detergent used in the device 20A is 180 g and its exhaustion rate is 15 g/day, the detergent will run out in 12 days from today. In this case, the replacement timing is 12 days from today.

Further, the notification timing of each replaceable component 30 is a timing at which the user of the corresponding device 20 is notified that the old replaceable component 30 used in the device 20 is nearing its replacement timing. The notification timing is a predetermined timing that is before the replacement timing. The notification timing is, for example, a day that is 7 days before the replacement timing. By notifying replacement information to the user of the device 20 at the notification timing, the user is expected to soon replace the old replaceable component 30 with the new replaceable component 30. The replacement information is information indicating that the replaceable component 30 used in the device 20 is nearing its replacement timing. Further, the user of the device 20 is expected to purchase the new replaceable component 30 to replace the replaceable component 30. That is, the user of the device 20 is expected to purchase the new replaceable component 30 at the notification timing. For example, in a case where the replacement information is notified 7 days before the replacement timing (at the notification timing), the user of the device 20 is expected to purchase the new replaceable component 30 on that day (which is 7 days before the replacement timing). The notification timing may be set arbitrarily by the user.

Further, the purchase timing of each replaceable component 30 is a timing at which the user of the corresponding device 20 is expected to purchase the new replaceable component 30. The user of the device 20 is assumed to purchase the new replaceable component 30 at the aforementioned notification timing. Thus, the purchase timing and the notification timing take place concurrently. For example, if the replacement timing is 12 days from today and the notification timing is 7 days before the replacement timing, the notification timing is in 5 days from today. Assuming that the user of the device 20 is to purchase the replaceable component 30 on that day (at the notification timing), the purchase timing is 5 days from today.

Next, the third table 503 will be described. As shown in FIG. 5, the third table 503 stores information related to quantities of the replaceable components 30. The third table 503 stores a total of purchase quantity of the replaceable components 30, an accumulated total of the total purchase quantity, a stock quantity of the replaceable components 30, and a stock shortage quantity thereof. The third table 503 is updated each time the replaceable components 30 are used in the devices 20.

The total of the purchase quantity of the replaceable components 30 is a total number of replaceable components 30 expected to be purchased by the users of the respective devices 20, which is calculated based on the purchase timings in the second table 502 shown in FIG. 4. For example, the user of the device 20C is expected to purchase a new replaceable component 30C in one day from today. Further, on this day (which is one day from today), the users of the other devices 20 are expected not to purchase any new replaceable components 30. Thus, in this case, the total of the purchase quantity of the replaceable components 30 in one day from today is one. Further, the accumulated total of the total purchase quantity is an accumulated total of the purchase quantity of the replaceable components 30 as above. For example, the accumulated total of the total purchase quantity in 5 days from today is three.

The stock quantity of the replaceable components 30 is a number of the stock of the replaceable components 30 expected to be stocked in the warehouse 300 of the administrator of the management system 1. For example, the stock quantity of the replaceable components 30 as of today is two. The stock quantity of the replaceable components 30 decreases when the users of the devices 20 purchase the new replaceable components 30. For example, a total of one replaceable component 30 is to be purchased in one day from today. In this case, the stock quantity of the replaceable components 30 decreases by one. Thus, the stock quantity of the replaceable components 30 in one day from today becomes one. Further, the stock quantity of the replaceable components 30 increases when the replaceable components 30 are delivered or scheduled to be delivered to the warehouse 300. In the example shown in FIG. 5, no replaceable components 30 are delivered to the warehouse 300, and no delivery is scheduled. Due to this, the stock quantity of the replaceable components 30 is not increased. Data of the stock quantity of the replaceable components 30 is sent from the first host computer 301 installed in the warehouse 300 of the administrator to the server 100.

Further, the stock shortage quantity of the replaceable components 30 is a number by which the stock of the replaceable components 30 is in shortage. The stock shortage quantity is calculated based on the accumulated total of the total purchase quantity of the replaceable components 30 and the stock quantity of the replaceable components 30. For example, it is assumed that the stock quantity of the replaceable components 30 as of today is two, no increase is made in the stock quantity, and the accumulated number of the total purchase quantity of the replaceable components 30 in 5 days from today is three. In this case, one replaceable component 30 will be in shortage in 5 days from today. Thus, the shortage quantity of the replaceable components 30 in 5 days from today is one.

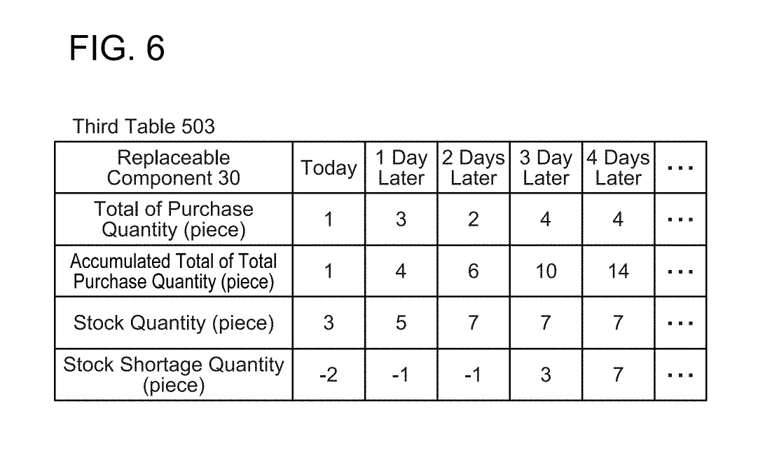

In the example shown in FIG. 5, the numbers related to the replaceable components 30 indicated in the third table 503 are small because the numbers of the devices 20 and the replaceable components 30 in the management system 1 are small. However, the numbers related to the replaceable components 30 indicated in the third table 503 become large in a case where the numbers of the devices 20 and the replaceable components 30 are large. For example, in the case where the numbers of the devices 20 and the replaceable components 30 are large as shown in FIG. 6, the total of the purchase quantity of the replaceable components 30, the accumulated total of the total purchase quantity, the stock quantity of the replaceable components 30, and the stock shortage quantity thereof become larger than the case shown in FIG. 5. In the example shown in FIG. 6, delivery of the replaceable components 30 to the warehouse 300 of the administrator of the management system 1 is scheduled, and thus the stock quantity of the replaceable components 30 is increased.

Next, processes executed in the aforementioned management system 1 will be described. In the management system 1, primarily, a registration process, an initial setting process, an operating process, a calculation process, a shortage quantity calculation process, a server-side notification process, a device-side notification process, and a shipping process are executed. These processes will be described hereinbelow.

(Registration Process)

In the aforementioned management system 1, firstly, the registration process is executed. The registration process is a process of registering the information related to the replaceable components 30 used in the devices 20. The registration process is a process executed when the user of one of the devices 20 replaces the old replaceable component 30 that was used in the device 20 with the new replaceable component 30. Here, the registration process in the device 20A among the plurality of devices 20 will be described. Same registration process is executed in each of the other devices 20B, 20C, 20D.

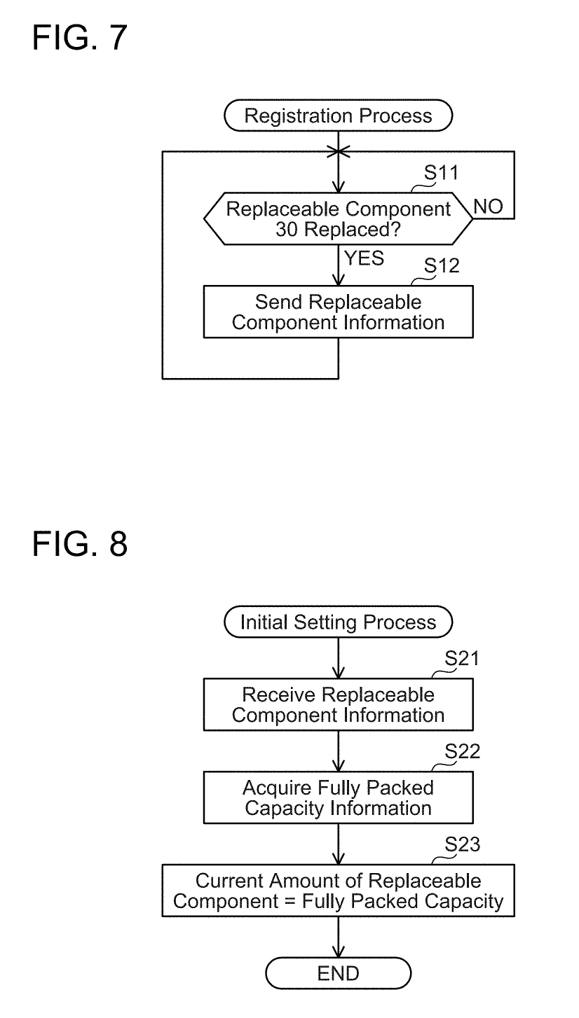

In the registration process, as shown in FIG. 7, the controller 21 of the device 20A monitors whether or not the replaceable component 30A used in the device 20A has been replaced in step S11. In a case where the replaceable component 30A has been replaced, the controller 21 determines YES in step S11 and proceeds to step S12. Whether or not the replaceable component 30A has been replaced can be determined, for example, based on a detection result from a sensor for detecting the replaceable component 30A. In a case where the sensor detects the new replaceable component 30A, it can be determined that the replaceable component 30A has been replaced. Alternatively, in the case where the replaceable component 30A has been replaced, the user may operate a switch which notifies the replacement. On the other hand, in a case where the replaceable component 30A is not replaced, the controller 21 determines NO in step S11 and stands by.

In subsequent step S12, the controller 21 of the device 20A sends replaceable component information related to the new replaceable component 30A to the server 100. The replaceable component information is information by which a type of the new replaceable component 30A can be identified. The replaceable component information is, for example, the product number of the new replaceable component 30A. After step S12 is completed, the controller 21 returns to step S11 and continues the monitoring.

(Initial Setting Process)

In the management system 1, the initial setting process is executed subsequent to the registration process. The initial setting process is a process for initially setting the information related to the replaceable components 30 in the server 100. Here, the initial setting process for the device 20A among the plurality of devices 20 will be described. Same initial setting process is executed for each of the other devices 20B, 20C, 20D. In the initial setting process, as shown in FIG. 8, the server 100 receives in step S21 the replaceable component information which the controller 21 of the device 20A had sent in the aforementioned step S12. The server 100 receives the replaceable component information (such as the product number) related to the new replaceable component 30A.

In subsequent step S22, the server 100 acquires fully packed capacity information of the new replaceable component 30A based on the received replaceable component information (such as the product number). The fully packed capacity information is information for identifying the fully packed capacity of the new replaceable component 30A. The server 100 acquires the fully packed capacity information from the first table 501 shown in FIG. 3. The server 100 acquires the fully packed capacity corresponding to the product number of the replaceable component 30A stored in the first table 501. The fully packed capacity of the replaceable component 30A is, for example, 500 g.

In subsequent step S23, the server 100 sets the fully packed capacity of the replaceable component 30A as the current amount of the replaceable component 30A. The initial current amount of the replaceable component 30A is set as the fully packed capacity. After this, the server 100 completes the process.

(Operating Process)

In the management system 1, operations of the devices 20 are executed by the users of the respective devices 20 using the devices 20. The operating process is a process executed when each device 20 is operated. Here, the operating process in the device 20A among the plural devices 20 will be described. Same operation process is executed in each of the other devices 20B, 20C, 20D.

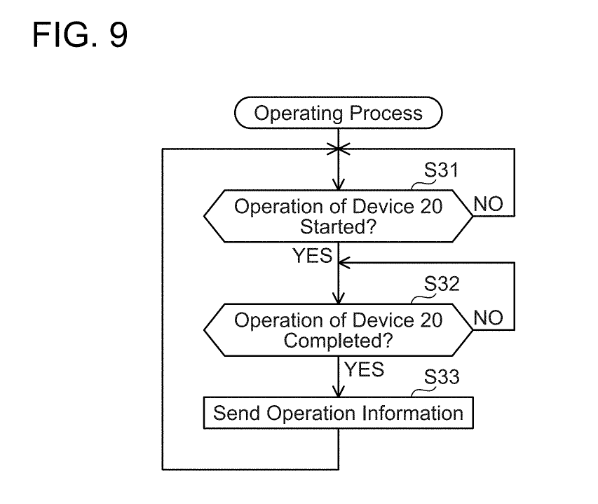

In the operating process, as shown in FIG. 9, the controller 21 of the device 20A monitors whether or not the operation of the device 20A has been started in step S31. In a case where the operation of the device 20A has been started, the controller 21 determines YES in step S31 and proceeds to step S32. On the other hand, in a case where the operation of the device 20A is not started, the controller 21 determines NO in step S31 and stands by. Whether or not the operation of the device 20A has been started can be determined based on an operation signal of the device 20A. In a case where the operation signal of the device 20A has been detected, it can be determined that the operation of the device 20A has been started.

In subsequent step S32, the controller 21 of the device 20A monitors whether or not the operation of the device 20A has been completed. In a case where the operation of the device 20A has been completed, the controller 21 determines YES in step S32 and proceeds to step S33. On the other hand, in a case where the operation of the device 20A is not completed, the controller 21 determines NO in step S32 and stands by. Whether or not the operation of the device 20A has completed can be determined based on the operation signal of the device 20A. In a case where the operation signal of the device 20A is no longer detected, it can be determined that the operation of the device 20A has been completed.

In subsequent step S33, the controller 21 of the device 20A sends operation information related to the operation of the device 20A to the server 100. The operation information is information that is capable of identifying that the operation of the device 20A was executed. Thus, this operation information is information that is capable of identifying that the replaceable component 30 was used in the device 20A. The operation information is information of an operation mode with which the operation of the device 20A was executed, for example. The operation mode is, for example, a normal mode, a deep cleansing mode, or the like. After step S33 is completed, the controller 21 of the device 20A returns to step S31 and continues the monitoring.

(Calculation Process)

In the management system 1, when the operating process is executed in the device 20, the calculation process is executed in the server 100. The calculation process is a process of executing various calculations related to the replaceable components 30.

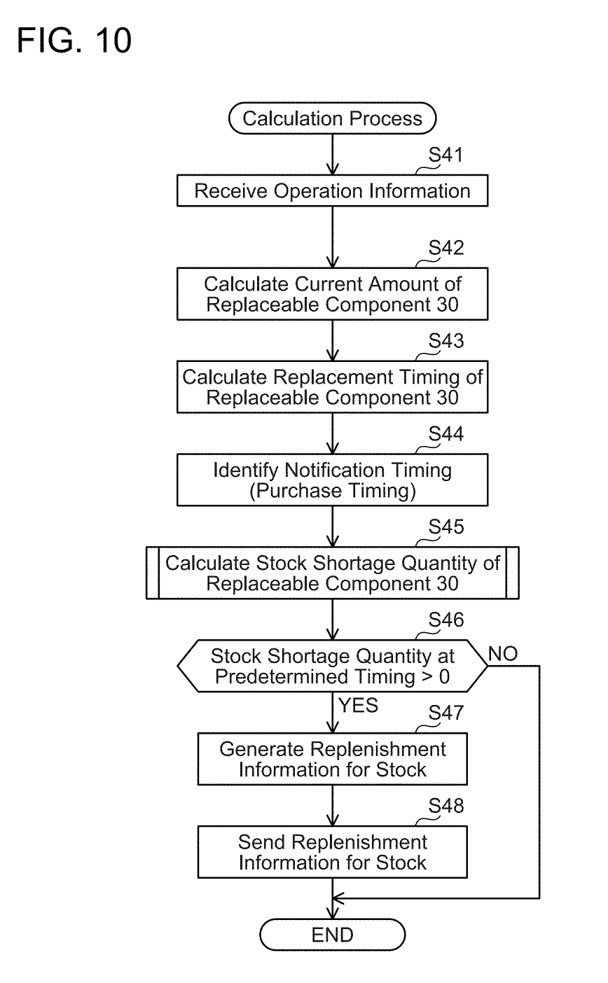

In the calculation process, as shown in FIG. 10, the server 100 receives in step S41 the operation information which the controller 21 of the relevant device 20 had sent in the aforementioned step S33. The server 100 receives the operation information from the devices 20A, 20B, 20C, 20D. The server 100 receives the operation information from one of the devices 20A, 20B, 20C, 20D each time the operation of the one of the devices 20A, 20B, 20C, 20D is executed.

In subsequent step S42, the server 100 calculates the current amount of the replaceable component 30 based on the operation information received from the corresponding device 20. The server 100 calculates the current amount of the relevant one of the replaceable components 30A, 30B, 30C, 30D used in the devices 20A, 20B, 20C, 20D related to the received operation information. For example, in the case of having received the operation information from the device 20A, the server 100 calculates the current amount of the replaceable component 30A used in the device 20A. At this occasion, the server 100 calculates the current amount of the replaceable component 30 based on the predetermined exhaustion amount (for example, 5 g/operation) of the replaceable component 30 stored in the second table 502 shown in FIG. 4. Each time the operation information is received, the server 100 calculates the current amount of the replaceable component 30 in the relevant device 20 after its operation by subtracting the predetermined exhaustion amount of the replaceable component 30 from the current amount of the replaceable component 30 in the relevant device 20 before the operation. That is, the current amount of the replaceable component 30 after use is calculated by subtracting the predetermined exhaustion amount from the current amount of the replaceable component 30 before the use. For example, in a case where the current amount of the replaceable component 30A before the operation of the device 20A (before the use of the replaceable component 30A) is 185 g and the predetermined exhaustion amount of the replaceable component 30A is 5 g/operation, the current amount of the replaceable component 30A after the operation of the device 20A (after the use of the replaceable component 30A) is 185 g−5 g=180 g.

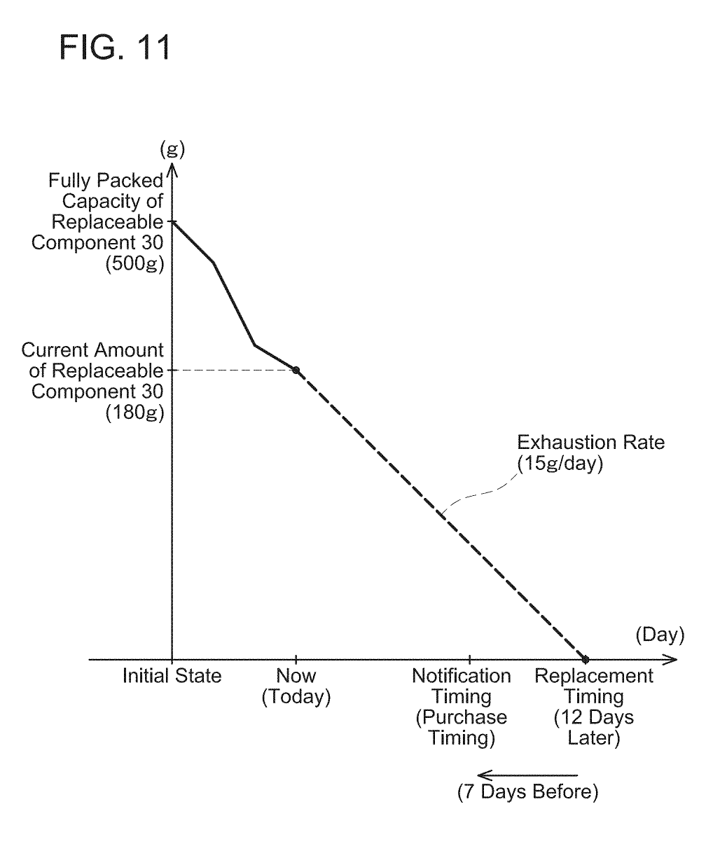

As shown in FIG. 10, in subsequent step S43, the server 100 calculates the replacement timing of the replaceable component 30. The server 100 calculates the replacement timing for the relevant one of the replaceable components 30A, 30B, 30C, 30D used in the respective devices 20A, 20B, 20C, 20D related to the operation information received in the aforementioned step S41. For example, in the case where the server 100 receives the aforementioned operation information from the device 20A, it calculates the replacement timing of the replaceable component 30A used in the device 20A. At this occasion, the server 100 calculates the replacement timing of the replaceable component 30 based on the predetermined exhaustion rate (for example, 15 g/day) of the replaceable component 30 stored in the second table 502 shown in FIG. 4. Further, the server 100 calculates the replacement timing based on the current amount of the replaceable component 30 calculated in the aforementioned step S42. Specifically, as shown in FIG. 11, the server 100 calculates a timing at which the amount of the replaceable component 30 (detergent) becomes 0 (zero) by assuming that the replaceable component 30 (detergent) is to be exhausted at the predetermined exhaustion rate, and sets that timing as the replacement timing. That is, the server 100 sets a timing at which the replaceable component 30 reaches the replacement state requiring its replacement, as the replacement timing. For example, in the case where the current amount of the replaceable component 30A used in the device 20A is 180 g and the predetermined exhaustion rate of the replaceable component 30A is 15 g/day, the amount of the replaceable component 30 becomes 0 (zero) in 12 days from now (today). Thus, the server 100 sets the timing that is 12 days from now (today) as the replacement timing. Each exhaustion rate is updated to a new exhaustion rate based on a past record of use of the replaceable component 30 (number of times used per day) in the corresponding device 20.

As shown in FIG. 10, in subsequent step S44, the server 100 identifies the notification timing based on the replacement timing calculated in the aforementioned step S43. As shown in FIG. 11, the notification timing is a predetermined timing before the replacement timing. For example, the notification timing may be a day that is 7 days before the replacement timing. The notification timing is a timing to notify the replacement information to the user of the relevant device 20. By notifying the replacement information to the user of the device 20, the user is expected to soon replace the old replaceable component 30 used in the device 20 with the new replaceable component 30. Thus, this user of the device 20 is expected to purchase the new replaceable component 30 at the notification timing. Due to this, the notification timing is concurrent as the purchase timing for the user of the device 20 to purchase the new replaceable component 30. That is, in step S44, the server 100 identifies the purchase timing (=the notification timing). The notification timing may be set arbitrarily by each user.

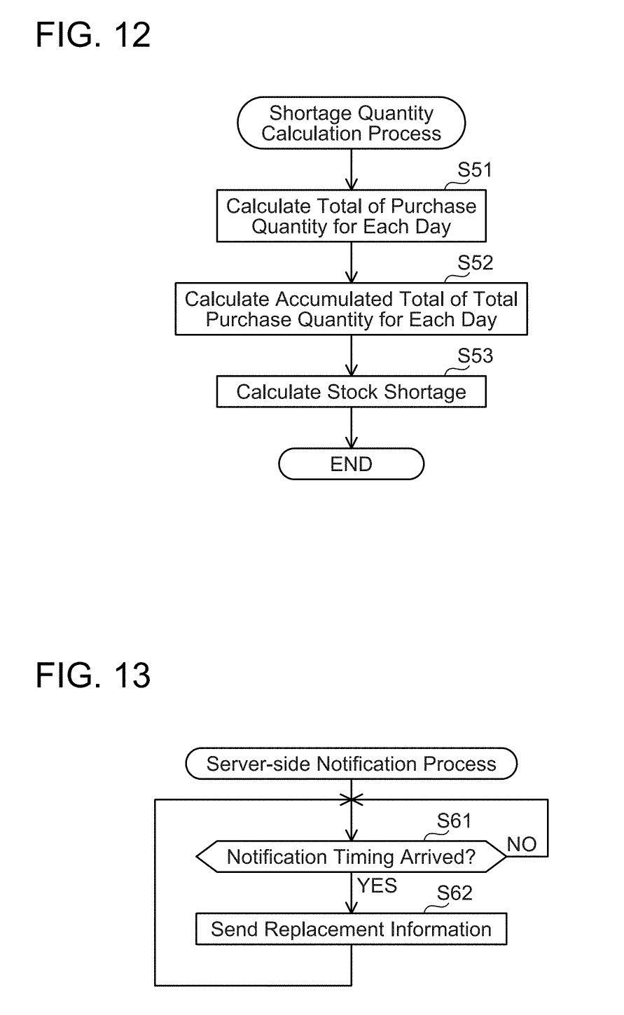

As shown in FIG. 10, in subsequent step S45, the server 100 calculates the stock shortage quantity of the replaceable components 30 (shortage quantity calculation process). The shortage quantity calculation process will be described with reference to FIG. 12. In the shortage quantity calculation process, as shown in FIG. 12, the server 100 calculates a total of the purchase quantity of the replaceable components 30 for each timing (day) in step S51. As aforementioned, the users of the devices 20 are expected to purchase the new replaceable components 30 at their purchase timings (=their notification timings). The users of the respective devices 20A, 20B, 20C, 20D are expected to purchase new replaceable components 30A, 30B, 30C, 30D at their respective purchase timings (=their respective notification timings). By accumulating all of those purchases, the total of the purchase quantity of the replaceable components 30 for each timing (day) can be calculated. For example, as shown in FIG. 4, the user of the device 20A is expected to purchase the new replaceable component 30A in 5 days from today. The users of the other devices 20B, 20C, 20D are expected not to purchase any new replaceable components 30 in 5 days from today. In this case, as shown in FIG. 5, the total of the purchase quantity of the replaceable components 30 in 5 days from today is one.

As shown in FIG. 12, in subsequent step S52, the server 100 calculates the accumulated total of the total purchase quantity of the replaceable components 30 for each timing (day). The accumulated total of the total purchase quantity of the replaceable components 30 for each timing (day) can be calculated by accumulating all of the totals of the purchase quantity of the replaceable components 30 from now (today) to the corresponding timing (day). For example, as shown in FIG. 5, when all of the totals of the purchase quantity of the replaceable components 30 from now (today) to 5 days from today (1 day from today: one, 2 days from today: one, 5 days from today: one) are accumulated, the accumulated total of the total purchase quantity of the replaceable components 30 in 5 days from today is 3.

As shown in FIG. 12, in subsequent step S53, the server 100 calculates the stock shortage quantity of the replaceable components 30 for each timing (day). The server 100 calculates the stock shortage quantity of the replaceable components 30 for each timing (day) by subtracting the accumulated total of the total purchase quantity of the replaceable components 30 for the relevant timing (day) calculated in step S52 from the stock quantity of the replaceable components 30 as of now (today). For example, as shown in FIG. 5, assuming that the stock quantity of the replaceable components 30 as of today is two and the accumulated total of the total purchase quantity of the replaceable components 30 in 5 days from today is three, the stock shortage quantity of the replaceable components 30 in 5 days from today is one. The stock quantity of the replaceable components 30 is sent to the server 100 from the first host computer 301 installed in the warehouse 300 of the administrator of the management system 1. In the example shown in FIG. 5, the stock of the replaceable components 30 is not increased. After having calculated the stock shortage quantity, the server 100 completes the shortage quantity calculation process.

After completing the shortage quantity calculation process, the server 100 proceeds to step S46 of the calculation process shown in FIG. 10. In step S46, the server 100 determines whether or not the stock shortage quantity of the replaceable components 30 at a predetermined timing is greater than 0 (zero). That is, the server 100 determines whether or not the stock of the replaceable components 30 at the predetermined timing is in shortage. This predetermined timing is, for example, a number of days required for the replaceable components 30 to be delivered to the warehouse 300 of the administrator of the management system 1 from the supplier, and it is 5 days from today, for example. In a case where the stock shortage quantity of the replaceable components 30 at the predetermined timing is greater than 0 (zero), the server 100 determines YES in step S46 and proceeds to step S47. For example, as shown in FIG. 5, since the stock shortage quantity of the replaceable components 30 in 5 days from today is one, the server 100 determines that the stock of the replaceable components 30 will be in shortage in step S46 and proceeds to step S47. On the other hand, in a case where the stock shortage quantity of the replaceable components 30 at the predetermined timing is equal to or less than 0 (zero), the server 100 determines NO in step S46, skips steps S47, S48 and completes the calculation process.

As shown in FIG. 10, in subsequent step S47, the server 100 generates replenishment information for the stock of the replaceable components 30. The replenishment information is information for replenishing the stock of the replaceable components 30 in accordance with the stock shortage quantity of the replaceable components 30. For example, as shown in FIG. 5, since the stock shortage quantity of the replaceable components 30 in 5 days from today is one, the server 100 generates the replenishment information that instructs to replenish the stock by one.

As shown in FIG. 10, in subsequent step S48, the server 100 sends the replenishment information regarding the stock of the replaceable components 30 to the second host computer 401 (see FIG. 1). The second host computer 401 is installed in the supplier warehouse 400. When the second host computer 401 receives the replenishment information from the server 100, the replaceable components 30 are shipped from the supplier warehouse 400 to the warehouse 300 of the administrator of the management system 1. The replaceable components 30 are shipped based on the replenishment information. For example, the replaceable component 30 is shipped so that one replaceable component 30 is delivered to the warehouse 300 of the administrator by 5 days from today. Further, due to the instruction of the shipment of the replaceable component 30, the stock quantity on a date (for example, 5 days later) when the replaceable component 30 is to be delivered to the warehouse 300 of the administrator is incremented by “1”.

(Server-Side Notification Process)

Next, the server-side notification process will be described. In the server-side notification process, as shown in FIG. 13, the server 100 monitors whether or not the notification timing has arrived in step S61. The notification timing is a timing that the server 100 identified in step S44 in the calculation process shown in FIG. 10. For example, as shown in FIG. 4, the notification timing for the replaceable component 30A used in the device 20A is 7 days before the replacement timing of the replaceable component 30A (5 days from today). The server 100 monitors whether or not this day has arrived. In a case where the notification timing has arrived, the server 100 determines YES in step S61 and proceeds to step S62. On the other hand, in a case where the notification timing has not arrived, the server 100 determines NO in step S61 and stands by.

As shown in FIG. 13, in subsequent step S62, the server 100 sends replacement information to the relevant device 20. The replacement information is information for notifying to replace the old replaceable component 30 used in the device 20 to a new replaceable component 30. The server 100 sends the replacement information to each of the devices 20 of which notification timings have arrived. For example, in a case where the notification timing has arrived for the device 20A, the replacement information is sent to the device 20A. After having completed step S62, the server 100 returns to step S61 and continues the monitoring.

(Device-Side Notification Process)

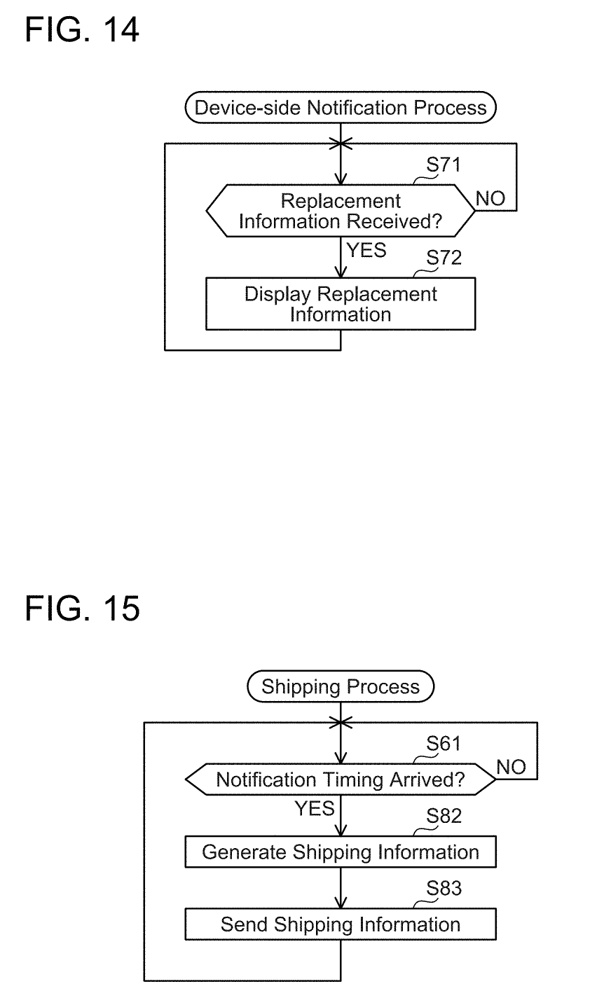

Next, the device-side notification process will be described. Here, the device-side notification process in the device 20A among the plurality of devices 20 will be described. Same device-side notification process is executed in the other devices 20B, 20C, 20D. In the device-side notification process, as shown in FIG. 14, the controller 21 of the device 20A monitors in step S71 whether or not the replacement information from the server 100 has been received. In a case of having received the replacement information, the controller 21 determines YES in step S71 and proceeds to step S72. On the other hand, in a case of not having received the replacement information, the controller 21 determines NO in step S71 and stands by.

In subsequent step S72, the controller 21 displays the replacement information on the display 22 of the device 20A. For example, the replacement information such as “The replaceable component 30A used in the device 20A will soon run out. Please prepare a new replaceable component 30A.” is displayed on the display 22. By doing so, the replacement information is notified to the user of the device 20A. By notifying the replacement information to the user of the device 20A, the user of the device 20A is expected to purchase a new replaceable component 30A to replace the replaceable component 30A. After step S72 is completed, the server 100 returns to step S71 and continues the monitoring.

As above, the management system 1 according to the first embodiment has been described. In the management system 1 as above, each of the devices 20 sends to the server 100 the operation information that is capable of identifying that the corresponding replaceable component 30 was used in the device 20 (step S33 of FIG. 9). When receiving the operation information from those devices 20 (step S41 of FIG. 10), the server 100 respectively calculates the replacement timings at which the replaceable components 30 used in those devices 20 reach the replacement state based on the predetermined exhaustion rates (see FIG. 4) of the replaceable components 30 used in those devices 20 (see step S43 of FIG. 10 and FIG. 11). Further, the server 100 sends the replacement information to the respective devices 20 at their predetermined timings (see FIGS. 4 and 11), which are before the corresponding calculated replacement timings of the replaceable components 30, for notifying the users that the replaceable components 30 used in the devices 20 are nearing their replacement timings (step S62 of FIG. 13). By doing so, the users of the devices 20 are expected to purchase new replaceable components 30. Further, based on the sending of the replacement information, the server 100 estimates the total of the purchase quantity of the replaceable components 30 to be purchased by the users of the devices 20 at each of the predetermined timings that are before the replacement timings (see step S51 of FIG. 12 and FIG. 5). Further, the server 100 calculates the stock shortage quantity of the replaceable components 30 at each of the predetermined timings based on the estimated total of the purchase quantity of the new replaceable components 30 and the stock quantity of the replaceable components 30 at each of the predetermined timings (see step S53 of FIG. 12 and FIG. 5). Further, the server 100 generates the replenishment information for replenishing the stock of the replaceable components 30 according to the calculated stock shortage quantity of the replaceable components 30 (step S47 of FIG. 10).

According to this configuration, the replacement timings can be calculated accurately, since the server 100 calculates the replacement timings of the replaceable components 30 based on the exhaustion rates of the replaceable components 30. Further, since the server 100 sends the replacement information to the devices 20 at the predetermined notification timings, which are before the replacement timings of the replaceable components 30, the users of the devices 20 can purchase the new replaceable components 30 at their predetermined purchase timings (=notification timings) which are before the replacement timings. Further, based on the sending of the replacement information, the server 100 estimates the total of the purchase quantity of the new replaceable components 30 to be purchased by the users of the devices 20 at the respective predetermined purchase timings (=the notification timings). That is, in the aforementioned management system 1, the server 100 estimates the total of the purchase quantity of the new replaceable components 30 based on the premise that the users of the devices 20 are to purchase the new replaceable components 30 at their predetermined purchase timings (=notification timings). Further, in the aforementioned management system 1, the server 100 calculates the stock shortage quantity of the replaceable components 30 at each of the predetermined purchase timings (=the notification timings) based on the estimated total of the purchase quantity of the new replaceable components 30 and the stock quantity of the replaceable components 30 at this predetermined purchase timing (=the notification timing) which is before its corresponding replacement timing, and as such, the purchases of the new replaceable components 30 by the users can be included in the schedule of stock management, so the stock shortage quantity of the replaceable components 30 can accurately be calculated. Further, since the server 100 generates the replenishment information for replenishing the stock of the replaceable components 30 according to the calculated stock shortage quantity, the stock quantity of the replaceable components 30 can suitably be managed. The stock of the replaceable components 30 can suitably be replenished in the warehouse 300 of the administrator of the management system 1.

While specific examples of the present invention have been described above in detail, these examples are merely illustrative and place no limitation on the scope of the patent claims. The technology described in the patent claims also encompasses various changes and modifications to the specific examples described above. In the description below, configurations that are identical to the aforementioned configurations will be given the same reference signs and explanation thereof will be omitted.

In the above embodiment, there was only one type of the replaceable components 30 (detergents), however, the stock quantities of plural types of detergents may be managed. The fully packed capacities of plural types of replaceable components 30 (detergents) may be different.

Further, in the above embodiment, the controllers 21 of the devices 20 sent the replaceable component information to the server 100 in the registration process (see FIG. 7), however, no limitation is made to this configuration. In another embodiment, the users of the devices 20 may input the replaceable component information to portable terminals such as smartphones, and the portable terminals may send the inputted replaceable component information to the server 100. Further, for example, the replaceable component information may be identified using barcodes given to the replaceable components 30.

Further, in the above embodiment, the server 100 sent the replacement information to the devices 20 in the server-side notification process (see FIG. 13), however, no limitation is made to this configuration. In another embodiment, the server 100 may send the replacement information to terminals (not shown) such as smartphones or personal computers instead of the devices 20 in the server-side notification process (see FIG. 13). The server 100 stores information of respective terminals associated with the corresponding devices 20. The server 100 sends the replacement information to the terminal corresponding to the relevant device 20. Further, in the device-side notification process (see FIG. 14), the terminals may receive the replacement information instead of the devices 20, and may display the replacement information on displays of the terminals. More specifically, receipt and display configurations using emails and applications may be considered. Further, in yet another embodiment, the server 100 may send the replacement information to both the devices 20 and the terminals.

### Second Embodiment

In the above embodiment, as shown in FIGS. 13 and 14, the notification processes (the server-side notification process and the device-side notification process) were executed, however, no limitation is made to this configuration. That is, in the notification processes, the server 100 sent the replacement information to the relevant device 20 (step S62) when the notification timing has arrived (YES in step S61), however, no limitation is made to this configuration. In another embodiment, a shipping process may be executed. In the shipping process, as shown in FIG. 15, when the notification timing has arrived (YES in step S61), the server 100 generates shipping information in subsequent step S82. The shipping information is information for shipping a new replaceable component 30 for replacement to the user of the device 20. The server 100 generates the shipping information for shipping the new replaceable component 30 for the replacement to the user of the device 20 of which notification timing has arrived. For example, in a case where the notification timing for the device 20A has arrived, the server 100 generates the shipping information for shipping the new replaceable component 30A for the replacement to the user of the device 20A.

In subsequent step S83, the server 100 sends the shipping information to the first host computer 301 (see FIG. 1). The first host computer 301 is installed in the warehouse 300 of the administrator of the management system 1. When the first host computer 301 receives the shipping information from the server 100, the new replaceable component 30 is shipped to the user of the device 20 from the warehouse 300 of the administrator. The new replaceable component 30 is shipped based on the replenishment information. For example, the new replaceable component 30A is shipped to the user of the device 20A of which notification timing (=purchase timing) has arrived. Due to this, the user of the device 20A can automatically purchase the new replaceable component 30A. After step S83 is completed, the server 100 returns to step S61 and continues the monitoring.

In this configuration, the server 100 estimates the total of the purchase quantity of the new replaceable components 30 to be purchased by the users of the devices 20 at their notification timings (=the purchase timings) based on the generation of the shipping information. That is, the server 100 estimates the total of the purchase quantity of the new replaceable components 30 on the premise that the users of the devices 20 are to purchase the new replaceable components 30 at their notification timings (=the purchase timings). Further, since the server 100 calculates the stock shortage quantity of the replaceable components 30 at each of the notification timings (=the purchase timings) based on the estimated total of the purchase quantity of the new replaceable components 30 and the stock quantity of the replaceable components 30 at that notification timing (=the purchase timing), the purchase of the new replaceable components 30 by the users can be included in the schedule of stock management, so the stock shortage quantity of the replaceable components 30 can accurately be calculated. Further, since the server 100 generates the replenishment information for replenishing the stock of the replaceable components 30 according to the calculated stock shortage quantity, the stock quantity of the replaceable components 30 can suitably be managed.

Further, in the second embodiment, both of the notification processes (the server-side notification process and the device-side notification process) shown in FIGS. 13 and 14 and the shipping process shown in FIG. 15 may be executed.

### Third Embodiment

Further, in the above embodiments, the devices 20 were dishwashers, however, no limitation is made to this configuration. In another embodiment, the devices 20 may be gas cooktops. Further, the replaceable components 30 in the above embodiments were detergents, however, no limitation is made to this configuration. In another embodiment, the replaceable components 30 may be pan supports. Alternatively, the replaceable components 30 may be burner heads.

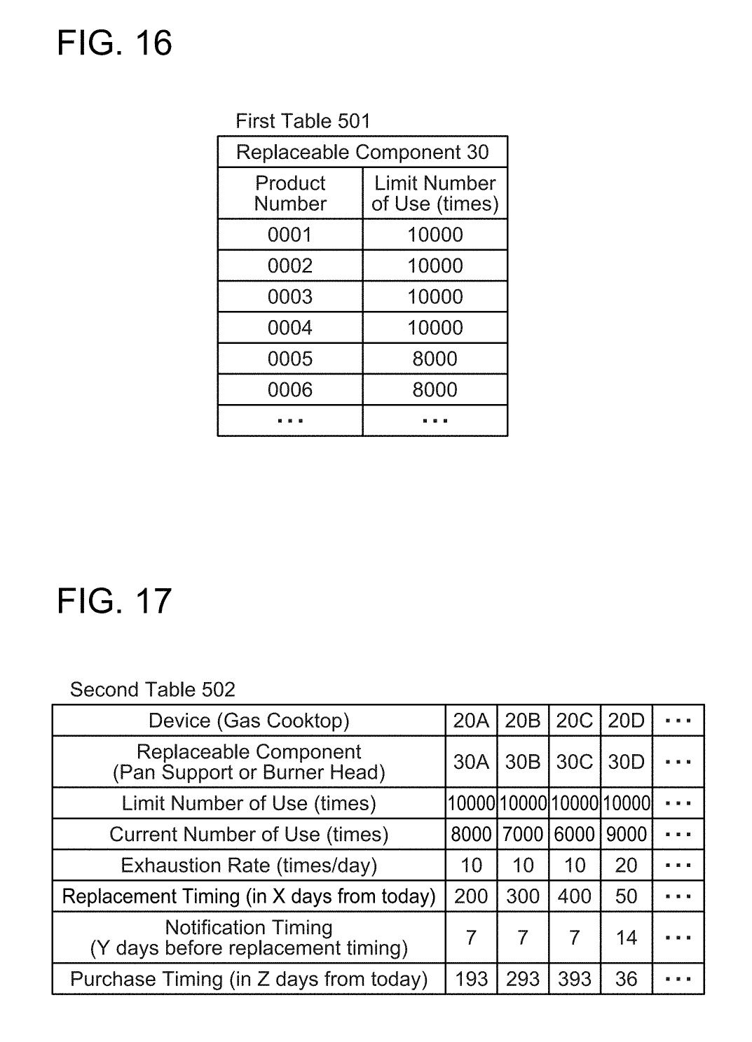

The first table 501 in the third embodiment will be described. As shown in FIG. 16, the first table 501 stores the product numbers and limit numbers of use of the replaceable components 30. Each product number is information by which a particular replaceable component 30 can be identified from the plural replaceable components 30. Each limit number of use is a limit number of times up to which the replaceable component 30 (the pan support or the burner head) in a brand-new state can be used. The replaceable component 30 (the pan support or the burner head) can be used up to the limit number of use. In the first table 501, the product numbers and the limit numbers of use of the replaceable components 30 are associated with each other.

Next, the second table 502 in the third embodiment will be described. As shown in FIG. 17, the second table 502 stores the information related to the replaceable components 30 used in the devices 20. The second table 502 stores the limit number of use, a current number of use, and an exhaustion rate of each replaceable component 30. Further, the second table 502 stores a replacement timing, a notification timing, and a purchase timing for each replaceable component 30.

The limit number of use of each replaceable component 30 stored in the second table 502 is the limit number of times up to which the pan support or the burner head in an initial state where the old replaceable component 30 is replaced with the new replaceable component 30 can be used. The limit number of use is, for example, 10,000 times.

Further, the current number of use of each replaceable component 30 is the number of times by which the pan support or the burner head has been used from its brand-new initial state until now. In the initial state where the old replaceable component 30 is replaced with the new replaceable component 30, the current number of use is zero. The current number of use of the replaceable component 30 increases each time the pan support or the burner head is used in the device 20.

The exhaustion rate (times/day) of each replaceable component 30 is a number of times the pan support or the burner head is used per day. The pan support or the burner head is used and is thereby exhausted. In the present embodiment, the replaceable component 30 (the pan support or the burner head) being exhausted means that the pan support or the burner head is used and its number of use (the current number of use) approaches the limit number of use. The exhaustion rate of each replaceable component 30 is calculated based on a past record of use of the replaceable component 30 in the device 20. For example, the exhaustion rate of the replaceable component 30A used in the device 20A is 10 times/day.

Further, the replacement timing of each replaceable component 30 is a timing at which the replaceable component 30 reaches the replacement state by being used and exhausted in the device 20. The replacement timing is a timing at which the old replaceable component 30 is expected to be replaced with the new replaceable component 30. The replacement timing is calculated based on the current number of use and the exhaustion rate of the replaceable component 30. For example, assuming that the current number of use of the pan support or the burner head used in the device 20A is 8,000 times and the exhaustion rate thereof is 10 times/day, the number of use (the current number of use) reaches the limit number of use in 200 days from today. Thus, the replacement timing in this case is 200 days from today.

The notification timings and the purchase timings in the second table 502 of the third embodiment are same as the notification timings and the purchase timings in the second table 502 of the first embodiment, so detailed descriptions thereof will be omitted. In the third embodiment as well, processes similar to those mentioned in the first embodiment are executed. The fully packed capacity of the replaceable component 30 in the first embodiment can be substituted with the limit number of use of the replaceable component 30 in the third embodiment, and the current amount of the replaceable component 30 in the first embodiment can be substituted with the current number of use of the replaceable component 30 in the third embodiment.

In the third embodiment, the limit number of use and the current number of use may be managed on time basis instead of number-of-times basis. Further, they may be managed both on time basis and on number-of-times basis. Further, they may be managed on one of number-of-times basis and time basis, whichever reaches the limit at an earlier stage.

### Fourth Embodiment

The specific examples of the replaceable components 30 are not limited to those in the aforementioned embodiments. In another embodiment, the replaceable components 30 may be batteries.

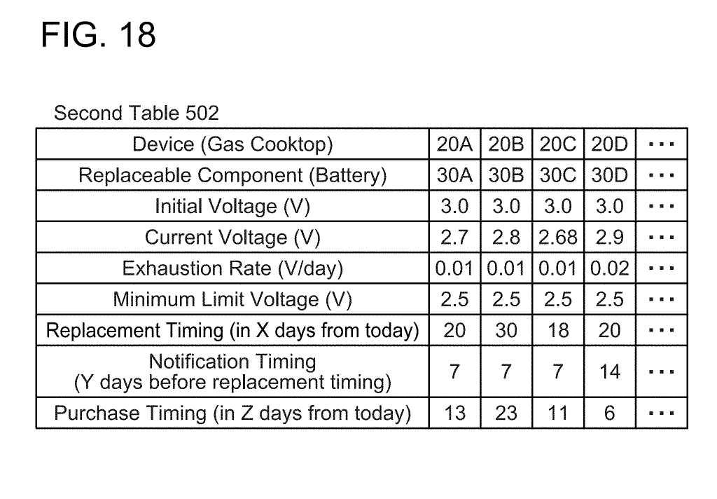

The second table 502 in a fourth embodiment will be described. As shown in FIG. 18, the second table 502 stores the information related to the replaceable components 30 used in the devices 20. The second table 502 stores an initial voltage, a current voltage, an exhaustion rate, and a minimum limit voltage of each replaceable component 30. Further, the second table 502 stores a replacement timing, a notification timing, and a purchase timing related to each replaceable component 30.

The initial voltage of each replaceable component 30 stored in the second table 502 is a voltage of the battery in an initial state where the old replaceable component 30 is replaced with the new replaceable component 30. The initial voltage is, for example, 3.0V.

Further, the current voltage of each replaceable component 30 is a current voltage of the battery. In the initial state where the old replaceable component 30 is replaced with the new replaceable component 30, the aforementioned initial voltage is the current voltage. The current voltage of the replaceable component 30 decreases each time the battery is used in the device 20.

The exhaustion rate (V/day) of each replaceable component 30 is a voltage of the battery that decreases each time the battery is used in the device 20. When the battery is used, this battery is exhausted and the voltage thereof decreases. In the present embodiment, the replaceable component 30 (battery) being exhausted means that the battery is used and the voltage thereof decreases. The exhaustion rate of each replaceable component 30 is calculated based on a past record of use of the replaceable component 30 in the device 20. For example, the exhaustion rate of the replaceable component 30A used in the device 20A is 0.01V/day.

The minimum limit voltage of each replaceable component 30 is a voltage at which the replaceable component 30 is required to be replaced. The replacement is required when the voltage of the battery reaches the minimum limit voltage. That is, the minimum limit voltage is a voltage at which the replaceable component 30 reaches the replacement state. The minimum limit voltage is, for example, 2.5V.

Further, the replacement timing of each replaceable component 30 is a timing at which the replaceable component 30 reaches the replacement state by being used and exhausted in the device 20. The replacement timing is a timing at which the old replaceable component 30 is expected to be replaced with the new replaceable component 30. The replacement timing is calculated based on the current voltage and the exhaustion rate of the replaceable component 30. For example, assuming that the current voltage of the battery used in the device 20A is 2.7V and its exhaustion rate is 0.01 V/day, the current voltage reaches the minimum limit voltage in 20 days from today. Thus, the replacement timing in this case is 20 days from today.

The notification timings and the purchase timings in the second table 502 of the fourth embodiment are same as the notification timings and the purchase timings in the second table 502 of the first embodiment, so detailed descriptions thereof will be omitted. In the fourth embodiment as well, processes similar to those mentioned in the first embodiment are executed. The current amount of the replaceable component 30 in the first embodiment can be substituted with the current voltage of the replaceable component 30 in the fourth embodiment.

In the fourth embodiment, in step S33 of the operating process shown in FIG. 9, the controller 21 of the relevant device 20 may send the current voltage of the replaceable component 30 (battery) as the operation information. In so doing, step S42 of the calculation process shown in FIG. 10 can be omitted. That is, the server 100 can omit step S42 for calculating the current voltage of the replaceable component 30 (battery).

Instead of the notification timing in the fourth embodiment, a voltage corresponding to the notification timing may be preset, a day on which this voltage is reached may be calculated based on the exhaustion rate, and this day may be set as the purchase timing. For example, assuming that the voltage corresponding to the notification timing is set to 2.6V, the exhaustion rate is 0.01 V/day, and the current voltage is 2.7V, 2.6V is reached in 10 days from today. Thus, the purchase timing is 10 days later.

### Fifth Embodiment

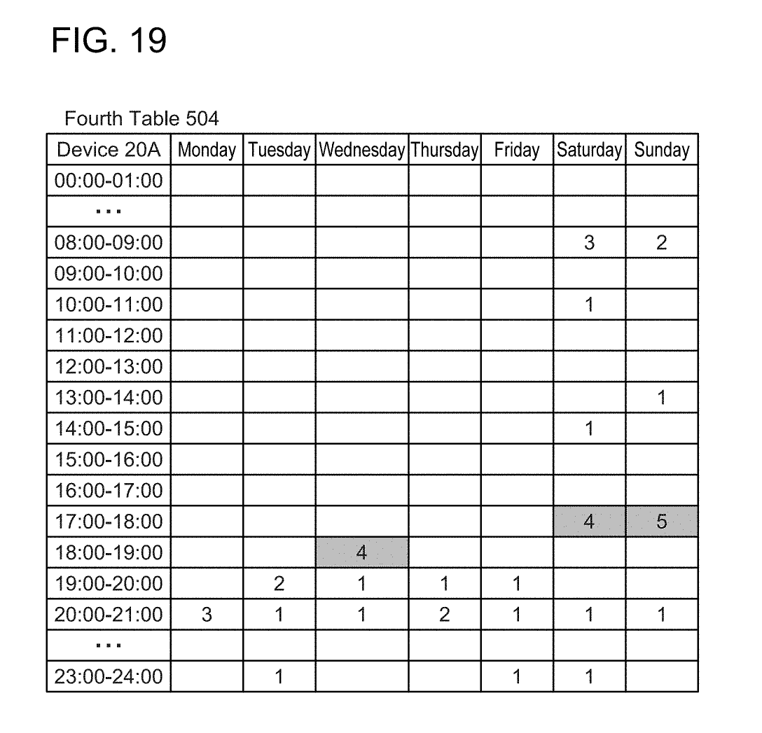

In the management system 1 according to a fifth embodiment, a fourth table 504 is stored in the server 100. As shown in FIG. 19, the fourth table 504 stores date information. Specifically, the fourth table 504 stores information capable of identifying a day of week (Monday to Friday) and a time range (0:00 to 01:00 through 23:00 to 24:00). The fourth table 504 is updated when the server 100 receives date information to be described later. The fourth table 504 is prepared for each of the devices 20A, 20B, 20C, 20D. FIG. 19 shows the fourth table 504 for the device 20A.

In the management system 1 according to the fifth embodiment, a date information sending process, a date information storing process, and a shipping process are executed. These processes will be described hereinbelow.

(Date Information Sending Process)

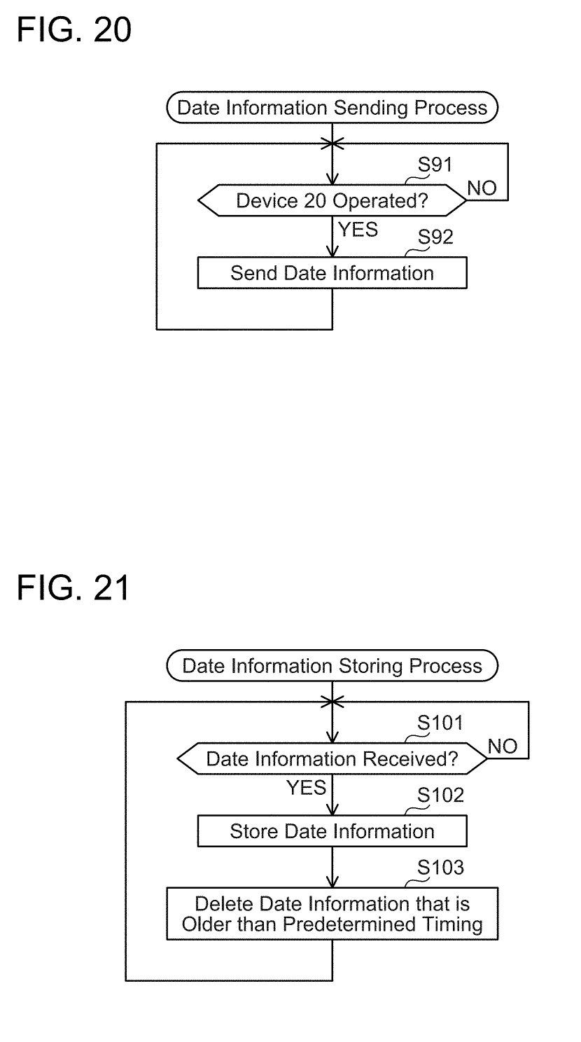

The date information sending process is a process executed when one of the devices 20 is operated by the user of this device 20. Here, the date information sending process in the device 20A among the plural devices 20 will be described. Same date information sending process is executed in the other devices 20B, 20C, 20D. In the date information sending process, as shown in FIG. 20, the controller 21 of the device 20A monitors whether or not the device 20A has been operated in step S91. In a case where the device 20A has been operated, the controller 21 determines YES in step S91 and proceeds to step S92. Whether or not the device 20A has been operated can be determined, for example, by detecting that an operation switch of the device 20A has been pressed. The operation switch of the device 20A is, for example, a switch to start washing the dishes in the case where the device 20A is a dishwasher. In a case where the operation switch of the device 20A has been pressed, it can be determined that the device 20A has been operated. On the other hand, in a case where the device 20A is not operated, the controller 21 determines NO in step S91 and stands by.

In subsequent step S92, the controller 21 of the device 20A sends date information to the server 100. The date information is information capable of identifying a date when the device 20A was operated by the user. For example, in a case where the device 20A was operated in the time range of 17:00 to 18:00 on Sunday, the date information is information identifying the time range of 17:00 to 18:00 on Sunday. After step S92 is completed, the controller 21 returns to step S91 and continues the monitoring.

(Date Information Storing Process)

Next, the date information storing process will be described. In the date information storing process, as shown in FIG. 21, the server 100 monitors in step S101 whether or not the date information has been received from the controller 21 of the device 20A. In a case of having received the date information, the server 100 determines YES in step S101 and proceeds to step S102. On the other hand, in a case where the date information has not been received, the server 100 determines NO in step S101 and stands by.

In subsequent step S102, the server 100 stores the received date information in the fourth table 504 shown in FIG. 19. Specifically, the server 100 adds “+1” point to the day of week and the time range identified by the received date information. For example, the server 100 adds “+1” point to the time range of 17:00 to 18:00 on Sunday in the fourth table 504. Each time a point is added, a score for the day increases. As above, the date information is stored in the fourth table 504. Even if a plurality of date information is sent for the same time range on the same day, a point is added only for the first time, and no point is added for the date information received thereafter.

As shown in FIG. 21, in subsequent step S103, the server 100 deletes the date information that is older than a predetermined timing from the fourth table 504. For example, the server 100 deletes the date information that was received on or before 60 days from today. Due to this, the date information received today and during the last 60 days remains in the fourth table 504. After step S103 is completed, the server 100 returns to step S101 and continues the monitoring. The server 100 executes the same date information storing process for each of the other devices 20B, 20C, 20D.

(Shipping Process)

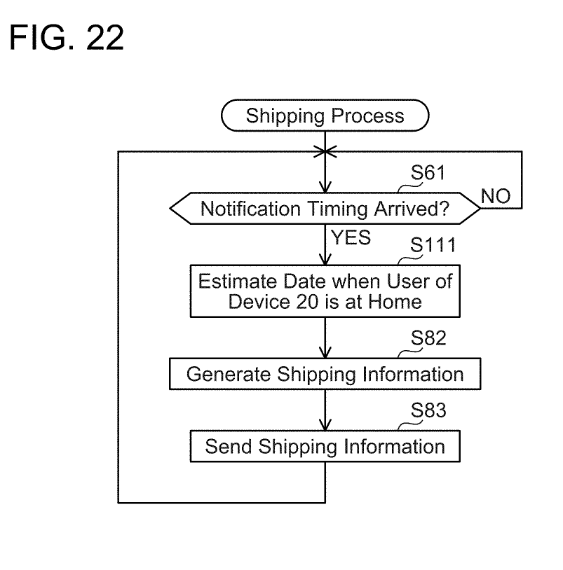

Next, the shipping process will be described. In the aforementioned second embodiment, the shipping process (see FIG. 15) did not consider date, however, no limitation is made to this configuration. In the fifth embodiment, the date is considered in the delivery process. In the delivery process according to the fifth embodiment, as shown in FIG. 22, the server 100 proceeds to step S111 when the notification timing has arrived (YES in step S61).

In step S111, the server 100 estimates a date when the user of the device 20A is at home. The server 100 estimates the date when the user of the device 20A is at home based on the fourth table 504 shown in FIG. 19. Specifically, the server 100 estimates that the user of the device 20A is at home on the date having a score equal to or greater than a predetermined score (for example, 4 points) in the fourth table 504. The user of the device 20A is more likely to be at home on the date having a high score in the fourth table 504. Accordingly, the server 100 estimates that the user of the device 20A is at home on the date having a high score in the fourth table 504. For example, the server 100 estimates that the user of the device 20A is at home during 18:00 to 19:00 on Wednesday, 17:00 to 18:00 on Saturday, and 17:00 to 18:00 on Sunday.

As shown in FIG. 22, in subsequent step S82, the server 100 generates shipping information. In this case, the server 100 generates the shipping information according to the date when the user of the device 20A is at home as estimated in step S111. The server 100 generates the shipping information so that the new replaceable component 30A is delivered on the date corresponding to the date when the user of the device 20A is at home. For example, the server 100 generates the shipping information so that the new replaceable component 30A is delivered to the user of the device 20A during 17:00 to 18:00 on Sunday.

In subsequent step S83, the server 100 sends the shipping information to the first host computer 301 (see FIG. 1). The first host computer 301 is installed in the warehouse 300 of the administrator of the management system 1. When the first host computer 301 receives the shipping information from the server 100, the new replaceable component 30A is shipped from the warehouse 300 of the administrator to the user of the device 20A. The new replaceable component 30A is shipped based on the shipping information. Due to this, the new replaceable component 30A is delivered on the date corresponding to the date when the user of the device 20A is at home. After step S83 is completed, the server 100 returns to step S61 and continues the monitoring. The server 100 executes the same shipping process for each of the other devices 20B, 20C, 20D.

As above, the management system 1 according to the fifth embodiment was described. In the fifth embodiment, when the devices 20 are operated by their users, each of the devices 20 sends the date information to the server 100 (step S92 of FIG. 20) which is capable of identifying the date when the operation took place. Further, in the case of generating the shipping information, the server 100 estimates the date when the user of each device 20 is at home based on the date information received from the device 20 (step S111 of FIG. 22). Further, the server 100 generates the shipping information so that the new replaceable component 30 is delivered to the user of the relevant device 20 on the date corresponding to the estimated date of the user being at home (see step S82 of FIG. 22 and FIG. 19).

According to this configuration, since the date when the user is at home is estimated based on the date information, the date when the user is at home can be estimated accurately. Further, since the server 100 generates the shipping information so that the new replaceable component 30 is delivered to the user of the relevant device 20 on the date corresponding to the estimated date, a possibility that the new replaceable component 30 is delivered on the date when the user is at home can be increased.

In the above embodiments, the date information was sent to the server 100 when each device 20 was operated, however, no limitation is made to this configuration. In another embodiment, the date information may be sent to the server 100 when the device 20 runs regardless of the operation to the device 20 by the user. In such a configuration, there is a possibility that the user may not be at home if the device 20 runs by a timer, and thus the date information is preferably configured not to be sent to the server 100. In the case of such a configuration, a communication volume can be suppressed as compared to the configuration of sending the date information to the server 100 each time the user operates the device 20.

What is claimed is:

1. A management system comprising:
a server; and
a plurality of devices configured to communicate with the server,
wherein
a replaceable component is used in each of the devices,
each of the replaceable components used in the devices is to be replaced with a new replaceable component when the replaceable component reaches a replacement state, the replacement state being a state in which the replaceable component is required to be replaced due to exhaustion by use,
each of the devices sends information to the server, the information being capable of identifying that the replaceable component was used in the device, and
the server is configured to:
when receiving the information from one of the devices, calculate a replacement timing for the replaceable component used in the device based on a predetermined exhaustion rate of the replaceable component used in the device, the replacement timing being a timing at which the replaceable component used in the device reaches the replacement state, and
at a predetermined timing before the calculated replacement timing for each of the replaceable components, the server is further configured to:
send replacement information to the device among the devices and/or a terminal corresponding to the device, the replacement information being for informing a user of the device that the replacement timing of the replaceable component used in the device is nearing and/or generate shipping information for shipping the new replaceable component to the user of the device;
based on the sending of the replacement information and/or based on the generating of the shipping information, estimate a total number of the new replaceable components to be purchased by the user of the device at the predetermined timing that is before the replacement timing;
based on the estimated total number of the new replaceable components to be purchased and based on a stock quantity of the replaceable components at the predetermined timing, calculate a quantity of stock shortage of the replaceable components at the predetermined timing; and
generate replenishment information for replenishing stock of the replaceable components according to the calculated quantity of stock shortage of the replaceable components.

2. The management system according to claim 1, wherein
each of the devices sends date information to the server in a case of being operated by the user, the date information being capable of identifying a date on which the device was operated by the user, and
in the case of generating the shipping information for one of the devices, the server is configured to:
estimate a date on which the user of the device is at home, based on the date information received from the device; and
generate the shipping information so that the new replaceable component is delivered to the user of the device at the date corresponding to the estimated date on which the user is at home.
